(19) United States
(12) Patent Application Publication
(10) Pub. No.: US 2024/0277022 A1
(43) Pub. Date: Aug. 22, 2024

(54) COATING DEVICE AND METHOD

(71) Applicant: MAREL FURTHER PROCESSING B.V., Boxmeer (NL)

(72) Inventors: Wilhelmus Johannes Jacobus Maria VAN DER STRAATEN, Boxmeer (NL); Johannes Martinus MEULENDIJKS, Boxmeer (NL); Bart Henricus Jozef VERBERK, Boxmeer (NL); Luc Wilhelmus Antonius DORPMANNS, Boxmeer (NL)

(21) Appl. No.: 18/569,077

(22) PCT Filed: Jun. 28, 2022
(86) PCT No.: PCT/EP2022/067778

§ 371 Date: Dec. 11, 2023

(30) Foreign Application Priority Data
Jun. 29, 2021 (NL) 2028570

(51) Int. Cl. A23P 20/12; B05C 19/06

(52) U.S. Cl. CPC A23P 20/12; B05C 19/06

(57) ABSTRACT

A coating device and a method for coating a food product with a pulverulent material by a coating device. The coating device includes a conveyor belt in a housing for conveying the food product in a conveying direction. The conveyor belt is at least partly permeable for the pulverulent material. A first layer of the pulverulent material is generated that lies on the conveyor belt onto which the food product is placeable. The coating device includes a coater for applying a second layer of the pulverulent material to the food product. A lower bunker is arranged within the conveyor belt for storing and receiving the pulverulent material that passes through the conveyor belt downstream of the guide plate. A plate delimits an upstream end of the lower bunker for retaining the pulverulent material in the lower bunker and to create a buffer of the pulverulent material in the lower bunker.

### BACKGROUND

The present invention relates to a coating device for coating a food product with a pulverulent material and a method for coating a food product with a pulverulent material by means of such a coating device.

Food products, like meat or fish, often need to be coated with a pulverulent material, like flour or breadcrumbs, before further processing or freezing the food product. Coating the food product can be done by an active coating device. Such a coating device comprises a conveyor belt for conveying the food product. The conveyor belt can be a wire mesh. Thus, the pulverulent material can pass through the conveyor belt. The coating device further comprises a coater, a lower bunker, an upper bunker, and a conveyor for conveying the pulverulent material from the lower bunker to the upper bunker.

A bed or layer of the pulverulent material is provided on the conveyor belt. The food product is placed on that layer of pulverulent material. The food product is then conveyed to the coater that is placed above the food product. The coater applies a further layer of the pulverulent material on top of the food product to cover it completely with the pulverulent material. Superfluous pulverulent material that does not adhere to the food product passes through the mesh-like conveyor belt into the lower bunker that provides a buffer of the pulverulent material. The pulverulent material is transported from the lower bunker to the upper bunker by means of the conveyor that is placed on one lateral side of the conveyor belt. The upper bunker supplies the pulverulent material to the coater.

From US2007/0264397 a coating device is known comprising a conveyor belt having a lower return path. Pulverulent material passes through the conveyor and falls onto the lower return path. In addition, pulverulent material from an external bunker is supplied to the lower return path. The coating material falls from the lower return path into a cross-feed screw.

This cross-feed screw transports part of the pulverulent material to a spreader screw applying a first (bottom) layer of pulverulent material that lies on the conveyor belt, onto which the products are placed. A guide plate is provided under the conveyor belt to generate the first layer of material.

The cross-feed screw transports another part of the pulverulent material to a chute supplying an upper bunker with material. A second (upper) layer of pulverulent material is applied onto the products from a coater provided above the conveyor, which coater is filled by the upper bunker.

### SUMMARY

It is an object of the present invention to provide an improved coating device for coating a food product with a pulverulent material.

This is achieved by a coating device and a method for coating a food product with a pulverulent material by means of such a coating device, relating to a coating device for coating a food product with a pulverulent material, comprising:
a conveyor belt arranged in a housing for conveying the food product in a conveying direction, wherein the conveyor belt is at least partly permeable for the pulverulent material, wherein a guide plate provided at an upstream end under the conveyor belt, seen in conveying direction, prevents the pulverulent material from passing the conveyor belt, generating a first layer of the pulverulent material that lies on the conveyor belt onto which the food product is placeable,
an upper bunker for storing the pulverulent material,
a coater for applying a second layer of the pulverulent material to the food product being conveyed by means of the conveyor belt, wherein the coater is supplied with the pulverulent material from the upper bunker,
a lower bunker arranged within the conveyor belt for storing the pulverulent material and for receiving the pulverulent material that passes through the conveyor belt downstream of the guide plate, seen in conveying direction,
a plate delimiting an upstream end of the lower bunker for retaining the pulverulent material in the lower bunker and to create a buffer of the pulverulent material in the lower bunker, wherein by adjusting a gap between the plate and the housing a thickness of a first layer of the pulverulent material can be adjusted,
a first upwards screw conveyor for conveying the pulverulent material from the lower bunker to the upper bunker,
a second upwards screw conveyor for conveying the pulverulent material from the lower bunker to the upper bunker, wherein the first upwards screw conveyor and the second upwards screw conveyor are arranged on both lateral sides of the conveyor belt,
a lateral screw conveyor provided in the lower bunker for conveying the pulverulent material to the first upwards screw conveyor and to the second upwards screw conveyor, and
a supply screw conveyor protruding into the lower bunker downstream of the lateral screw conveyor for conveying the pulverulent material from an external bunker to the lower bunker.

Accordingly, a coating device for coating a food product with a pulverulent material is provided. The coating device comprises a conveyor belt for conveying the food product, wherein the conveyor belt is at least partly permeable for the pulverulent material, an upper bunker for storing the pulverulent material, a coater for applying the pulverulent material to the food product being conveyed by means of the conveyor belt, wherein the coater is supplied with the pulverulent material from the upper bunker, a lower bunker for storing the pulverulent material and for receiving the pulverulent material that passes through the conveyor belt, a first upwards screw conveyor for conveying the pulverulent material from the lower bunker to the upper bunker, a second upwards screw conveyor for conveying the pulverulent material from the lower bunker to the upper bunker, wherein the first upwards screw conveyor and the second upwards screw conveyor are arranged on both lateral sites of the conveyor belt, a lateral screw conveyor for conveying the pulverulent material to the first upwards screw conveyor and to the second upwards screw conveyor, and a supply screw conveyor for conveying the pulverulent material from an external bunker to the lower bunker.

The inventive coating device and method result in a more uniform particle size distribution of the pulverulent material. When handling particulate coating material, inevitably impact on the material will cause damage and resulting relatively fine particles. Hence, the more handling, the more fine particles, the less uniform the particle size distribution. The inventive coating device and method is in particular advantageous for pulverulent material having a relatively large particle size such as breadcrumbs.

Since there are provided two upwards screw conveyors that are placed on both lateral sides of the conveyor belt, it is possible to supply the pulverulent material to the upper bunker in a symmetric fashion. Thus, an evenly distribution of the pulverulent material along a width direction of the coating device is ensured. This enables broadening the coating device and in particular the conveyor belt, for example from 700 mm to 1,000 mm. Hence, the capacity of the coating device can be increased.

The food product can be fish or meat, like poultry, beef, lamb, or the like. In particular, the food product is a thin cut of fish or meat. The pulverulent material can be flour or fine breadcrumbs. Preferably, the pulverulent material has a particle size smaller than 5 mm. The function of the coating device is to coat the food product completely with the pulverulent material. After coating the food product, it can be fried, frozen or processed further in any arbitrary way. The coating device is an active flour applicator or can be named active flour applicator. “Active” in this context means that the coating device coats the food product with the pulverulent material automatically. No handwork is needed to coat the food product with the pulverulent material.

The conveyor belt is an endless belt. “Endless” in this context means that the conveyor belt is circumferentially closed. The conveyor belt is guided around rollers of which at least one is driven by a drive. The conveyor belt can be made of metal or plastic. Preferably, the conveyor belt is made of a wire material, in particular a wire mesh. Thus, the conveyor belt is permeable for the pulverulent material. The pulverulent material can pass through the conveyor belt along a direction of gravity.

“Partly” permeable in this context means that the conveyor belt can have areas where it is permeable for the pulverulent materials and other areas where it is not permeable for the pulverulent material. The conveyor belt is guided by means of guide plates under the conveyor belt. In areas of the conveyor belt that are guided by means of the guide plates, the pulverulent material cannot pass the conveyor belt, because the guide plates prevent the pulverulent material from passing the conveyor belt. In areas of the conveyor belt that are not guided by means of the guide plates, the pulverulent material can pass the conveyor belt.

The coating device has a coordinate system comprising a length direction or x-direction, a height direction or y-direction and a width direction or z-direction. The directions are arranged perpendicular to each other. “Vertical” in this context means parallel to the y-direction. “Horizontal” in this context means parallel to the z-direction. The y-direction is arranged parallel to the direction of gravity. The conveyor belt is configured to transport the food product through the coating device along a conveying direction. The conveying direction can be arranged perpendicular toward the direction of gravity. Preferably, the conveying direction is arranged parallel to the x-direction.

The upper bunker can also be named first bunker, upper reservoir or first reservoir. The upper bunker stores the pulverulent material that is then supplied to the coater. The upper bunker can comprise a conveyor belt that conveys the pulverulent material from the upper bunker to the coater. The upper bunker is cuboid-shaped or container-shaped. The upper bunker comprises two opposing sidewalls or lateral sidewalls. When seen along the direction of gravity or the y-direction, the upper bunker is arranged on top of or above the lower bunker. In other words, the lower bunker is located below the upper bunker.

The coater is arranged downstream the conveyor belt of the bunker. “Downstream” in this context means that the pulverulent material is guided from the upper bunker to the coater and not vice versa. Thus, a flow direction of the pulverulent material is directed from the upper bunker toward the coater. The coater is a shaking belt or comprises a shaking belt that moves to the left and to the right in a direction that is arranged perpendicular to the conveying direction. The coater evenly distributes the pulverulent material on the food product. The food product is arranged between the conveyor belt and the coater.

The lower bunker can also be named second bunker, lower reservoir or second reservoir. Preferably, the lower bunker is arranged within the conveyor belt. That means that the endless conveyor belt runs around the lower bunker. In the lower bunker, a buffer of the pulverulent material is stored. Additionally, the pulverulent material that passes through the permeable conveyor belt is also received or collected in the lower bunker. Thus, the pulverulent material that passes through the conveyor belt can be recycled.

The first upwards screw conveyor can be named first vertical screw conveyor. “Screw conveyor” in this context means a conveyor that has a rotating conveying screw for transporting the pulverulent material. The first upwards screw conveyor can be named first upwards auger or first vertical auger. “Vertical” in this context means parallel to the y-direction. However, the first upwards screw conveyor can also be arranged inclined or obliged toward the y-direction. In other words, the first upwards screw conveyor can either be placed vertically or in an inclined or obliged way.

The first upwards screw conveyor is configured to transport the pulverulent material against the direction of gravity from the lower bunker to the upper bunker. The first upwards screw conveyor comprises a first upwards conveying screw and a housing for receiving the first upwards conveying screw. The first upwards conveying screw is driven by a drive. The drive can be an electric motor. The first upwards conveying screw can be named first vertical conveying screw.

The second upwards screw conveyor can be named second vertical screw conveyor. The second upwards screw conveyor can be named second upwards auger or second vertical auger. As the first upwards screw conveyor, the second upwards screw conveyor can be placed parallel toward the y-direction or inclined toward the y-direction. The second upwards screw conveyor comprises a second upwards conveying screw and a housing for receiving the second upwards conveying screw. The second upwards conveying screw is also driven by a drive. The second upwards conveying screw can be named second vertical conveying screw. Preferably, the first upwards conveying screw and the second upwards conveying screw are arranged parallel to each other and with a distance from each other.

“Lateral side” in this context means that the conveyor belt has a first lateral side and a second lateral side when seen along the conveying direction. The lateral sides are oppositely arranged. The lateral sides are placed in a distance from each other when seen along the z-direction. On each of the lateral sides, one of the upwards screw conveyors is placed. For example, the first upwards screw conveyor is arranged at the first lateral side and the second upwards screw conveyor is arranged at the second lateral side.

The lateral screw conveyor can also be named horizontal screw conveyor. The lateral screw conveyor is configured to transport the pulverulent material along the z-direction or perpendicular to the conveying direction of the conveyor belt. The lateral screw conveyor comprises a lateral conveying screw. The lateral conveying screw can also be named horizontal conveying screw. The lateral screw conveyor is configured to transport the pulverulent material to both, the first upwards conveyor screw and the second upwards conveyor screw at the same time.

The supply screw conveyor comprises a supply conveyor screw that can be arranged horizontally. The supply conveyor screw is configured to transport the pulverulent material from the external bunker to the lower bunker. The external bunker can be part of the coating device. By means of the supply screw conveyor, pulverulent material that leaves the coating device together with the food product can be replaced.

According to an embodiment, the lateral screw conveyor comprises a lateral conveying screw, wherein the lateral conveying screw has a first thread and a second thread, wherein the first thread and the second thread have opposite directions of rotation.

Preferably, the first thread and the second thread have the same pitch. Since the first thread and the second thread have opposite directions of rotation, it is possible to transport the pulverulent material to the first upwards screw conveyor as well as to the second upwards screw conveyor at the same time with just one lateral conveying screw. As mentioned before, the lateral conveying screw can be named horizontal conveying screw. The lateral conveying screw is arranged horizontally. However, the lateral conveying screw can also be arranged in an inclined or angled way.

According to an embodiment, the first thread and the second thread meet at a center between the lateral sides of the conveyor belt.

There can be provided a gap between the first thread and the second thread. The first thread and the second thread can meet at a center of the lateral conveying screw. When seen along the z-direction, the conveyor belt can be split into a first portion or first half and a second portion or second half. The center is arranged between the first half and the second half.

According to an embodiment, the first thread is configured to convey the pulverulent material from the center between the lateral sides toward a first lateral side of the conveyor belt, wherein the second thread is configured to convey the pulverulent material from the center between the lateral sides toward a second lateral side of the conveyor belt.

The first thread can rotate counter-clockwise, wherein the second thread can run clockwise or vice versa. The lateral conveying screw thus allows a transport of the pulverulent material to both lateral sides at the same time.

According to an embodiment, the first thread and the second thread share a common shaft of the lateral conveying screw.

“Common” in this context means that the first thread and the second thread have only one shaft that supports both threads. Preferably, the first thread, the second thread and the shaft are formed integrally. This means that the first thread, the second thread and the shaft form one element or component. In service of the coating device, the shaft rotates around an axis of rotation that is arranged parallel to the z-direction. The shaft is driven by means of a drive. The drive can be an electric motor.

According to an embodiment, the first and the second thread are mounted on separate driven shafts. The separate driven shafts may be mounted independent from each other or mounted in an engaged fashion.

According to an embodiment, the first thread and the second thread have the same length when seen along the shaft.

This has the result that the same amount of pulverulent material is transported from the center between the lateral sides to each lateral side of the conveyor belt. Alternatively, the first thread and the second thread can have differing lengths.

According to an embodiment, a conveying direction of the upwards screw conveyors is arranged perpendicular toward a first conveying direction of the lateral screw conveyor and toward a second conveying direction of the lateral screw conveyor, wherein the first conveying direction and the second conveying direction are oppositely oriented.

“Perpendicular” in this context means an angle of 90°±10°, preferably of 90°±5°, more preferably of 90°±3°, more preferably of 90°±1°, more preferably of exactly 90°. The conveying direction of the upwards screw conveyors is arranged parallel to the direction of gravity and opposite to the direction of gravity. As mentioned before, the upwards screw conveyors can also be arranged in an orientation different from a vertical orientation. For example, the upwards screw conveyors can be arranged inclined toward the y-direction or the direction of gravity.

According to an embodiment, the upper bunker comprises a first inlet opening for the first upwards screw conveyor and a second inlet opening for the second upwards screw conveyor, wherein the first inlet opening and the second inlet opening are provided at opposing sidewalls of the upper bunker.

The first upwards screw conveyor is configured to supply the pulverulent material through the first inlet opening into the upper bunker. Accordingly, the second upwards screw conveyor is configured to transport the pulverulent material through the second inlet opening into the bunker. The opposing sidewalls are arranged parallel to each other. When seen along the z-direction, the opposing sidewalls are arranged with a distance from each other.

According to an embodiment, an axis of rotation of the first upwards screw conveyor and an axis of rotation of the second upwards screw conveyor are arranged parallel to each other, wherein an axis of rotation of the lateral screw conveyor is arranged perpendicular to the axis of rotation of the upwards screw conveyors.

The first upwards conveying screw rotates around the axis of rotation of the first upwards screw conveyor. Accordingly, the second upwards conveying screw rotates around the axis of rotation of the second upwards screw conveyor. The lateral conveying screw rotates around the axis of rotation of the lateral screw conveyor. The upwards conveying screws and the lateral conveying screw together form a conveying apparatus of the coating device.

According to an embodiment, an axis of rotation of the supply screw conveyor is arranged parallel to the axis of rotation of the lateral screw conveyor.

When seen along the conveying direction or the x-direction, the axis of rotation of the supply screw conveyor and the axis of rotation of the lateral screw conveyor are arranged with a distance from each other. The supply conveying screw rotates around the axis of rotation of the supply screw conveyor.

According to an embodiment, the supply screw conveyor laterally protrudes into the lower bunker, wherein an end of the supply screw conveyor is arranged centered in relation to the conveyor belt, or ends over the conveyor belt, e.g. just over a first half of the conveyor belt.

“Just over” in this context means that the supply screw conveyor ends in a short distance from the center of the conveyor belt. However, the supply screw conveyor can also protrude over the center. The supply screw conveyor protrudes from one of the lateral sides of the conveyor belt into the lower bunker.

According to an embodiment, the supply screw conveyor comprises a supply conveying screw and a supply housing for receiving their supply conveying screw, wherein the supply housing comprises one or more openings for a leaking distribution of the pulverulent material into the lower bunker. The opening is configured to provide a leaking distribution of the pulverulent material onto the conveyor belt, e.g. the first half of the conveyor belt.

Preferably, the supply housing is tube-shaped.

The pulverulent material leaves the supply housing through the circumferential opening when the supply conveying screw rotates in the supply housing. “Leaking distribution” in this context means that the pulverulent material overflows the upper edge of the opening when the supply conveying screw rotates in the supply housing. The pulverulent material is thus distributed on the (first half of the) conveyor belt.

When rotating the supply conveying screw in the supply housing, at least part of the pulverulent material may leak via the one or more openings into the lower bunker. Possibly, but not necessarily, part of the pulverulent material is still transported to the end of the supply housing. At the end of the supply housing this part of the pulverulent material is distributed over the conveyor belt. Advantageously, the end of the supply housing extends over a large part of the conveyor belt, at least centered in relation to the conveyor belt.

The openings in the supply housing and the end of the supply conveying screw attribute to the distribution of the pulverulent material from the external bunker into the lower bunker. In general, the more uniform the distribution, the less mechanical blending with the recycled pulverulent material is required to obtain uniform pulverulent material. And the less mechanical blending, the less damage to the pulverulent material.

Further, a method for coating a food product with a pulverulent material by means of such a coating device for coating the food product is provided. The coating device comprises a conveyor belt, an upper bunker, a coater, a first upwards screw conveyor, a second upwards screw conveyor, a lateral screw conveyor, and a supply screw conveyor. The method comprises the following steps: a) conveying the food product to the coater by means of the conveyor belt, b) coating the food product with the pulverulent material by means of a first layer of the pulverulent material that lies on the conveyor belt and a second layer of the pulverulent material that is applied to the food product by means of the coater, c) receiving pulverulent material that passes through the conveyor belt in the lower bunker, d) conveying pulverulent material from the lower bunker to the upper bunker on both lateral sides of the conveyor belt by means of the first upwards screw conveyor and the second upwards screw conveyor, and e) conveying pulverulent material from an external bunker to the lower bunker by means of the supply screw conveyor.

By conveying the pulverulent material from the lower bunker to the upper bunker on both lateral sides of the conveyor belt, it is possible to fill the upper bunker symmetrically. This enables to coat the food product evenly and with no difference when seen along a width of the conveyor belt. The width of the conveyor belt can thus be increased. During step a), the food product is placed on the layer of pulverulent material that is provided on the conveyor belt. This layer can be named bed or first layer. During step b), the pulverulent material is applied in a further layer on top of the food product to cover it completely with the pulverulent material. The further layer can be named second layer.

According to an embodiment, during step e), the supply screw conveyor replaces pulverulent material that is removed from the coating device by coating the food product.

In other words, the supply screw conveyor replaces only the pulverulent material that leaves the coating device together with the food products. The replaced pulverulent material is mixed with recycled pulverulent material that passed the conveyor belt by means of the lateral conveying screw.

The embodiments and features described for the proposed coating device apply accordingly to the proposed method and vice versa.

The invention further relates to a coating device for coating a food product with a pulverulent material, comprising:
a conveyor belt for conveying the food product, wherein the conveyor belt is at least partly permeable for the pulverulent material,
an upper bunker for storing the pulverulent material,
a coater for applying the pulverulent material to the food product being conveyed by means of the conveyor belt, wherein the coater is supplied with the pulverulent material from the upper bunker,
a lower bunker for storing the pulverulent material and for receiving the pulverulent material that passes through the conveyor belt,
a first upwards screw conveyor for conveying the pulverulent material from the lower bunker to the upper bunker,
a second upwards screw conveyor for conveying the pulverulent material from the lower bunker to the upper bunker, wherein the first upwards screw conveyor and the second upwards screw conveyor are arranged on both lateral sides of the conveyor belt,
a lateral screw conveyor for conveying the pulverulent material to the first upwards screw conveyor and to the second upwards screw conveyor, and
a supply screw conveyor for conveying the pulverulent material from an external bunker to the lower bunker.

The invention further relates to a method for coating a food product with a pulverulent material by means of a coating device for coating the food product, wherein the coating device comprises a conveyor belt, an upper bunker, a coater, a first upwards screw conveyor, a second upwards screw conveyor, a lateral screw conveyor, and a supply screw conveyor, the method comprising the following steps:
a) conveying the food product to the coater by means of the conveyor belt,
b) coating the food product with the pulverulent material by means of a first layer of the pulverulent material that lies on the conveyor belt and a second layer of the pulverulent material that is applied to the food product by means of the coater,
c) receiving pulverulent material that passes through the conveyor belt in the lower bunker,
d) conveying pulverulent material from the lower bunker to the upper bunker on both lateral sides of the conveyor belt by means of the first upwards screw conveyor and the second upwards screw conveyor, and
e) conveying pulverulent material from an external bunker to the lower bunker by means of the supply screw conveyor.

Further possible implementations or alternative solutions of the invention also encompass combinations—that are not explicitly mentioned herein—of features described above or below with regard to the embodiments. The person skilled in the art may also add individual or isolated aspects and features to the most basic form of the invention.

### BRIEF DESCRIPTION OF THE DRAWINGS

Further embodiments, features and advantages of the present invention will become apparent from the subsequent description and dependent claims, taken in conjunction with the accompanying drawings, in which:

FIG. 1 shows a schematic perspective view of one embodiment of a coating device for coating a food product with a pulverulent material;

FIG. 2 shows a further schematic perspective view of the coating device according to FIG. 1;

FIG. 3 shows a further schematic perspective view of the coating device according to FIG. 1;

FIG. 4 shows a further schematic perspective view of the coating device according to FIG. 1;

FIG. 5 shows a cross-sectional view of the coating device according to FIG. 1;

FIG. 6 shows a further cross-sectional view of the coating device according to FIG. 1;

FIG. 7 shows a further cross-sectional view of the coating device according to FIG. 1;

FIG. 8 shows a further cross-sectional view of the coating device according to FIG. 1;

FIG. 9 shows a further cross-sectional view of the coating device according to FIG. 1;

FIG. 10 shows a schematic perspective view of one embodiment of a conveying apparatus for the coating device according to FIG. 1;

FIG. 11 shows a schematic cross-sectional view of a food product for being covered with a pulverulent material by means of the coating device according to FIG. 1; and

FIG. 12 shows a flowchart of one embodiment of a method for coating a food product with a pulverulent material by means of the coating device according to FIG. 1.

### DETAILED DESCRIPTION OF VARIOUS EMBODIMENTS

In the Figures, like reference numerals designate like or functionally equivalent elements, unless otherwise indicated.

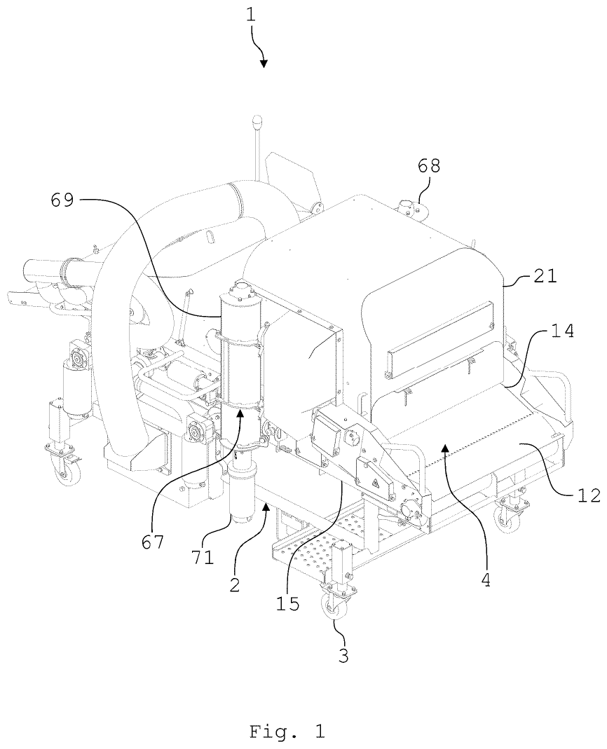

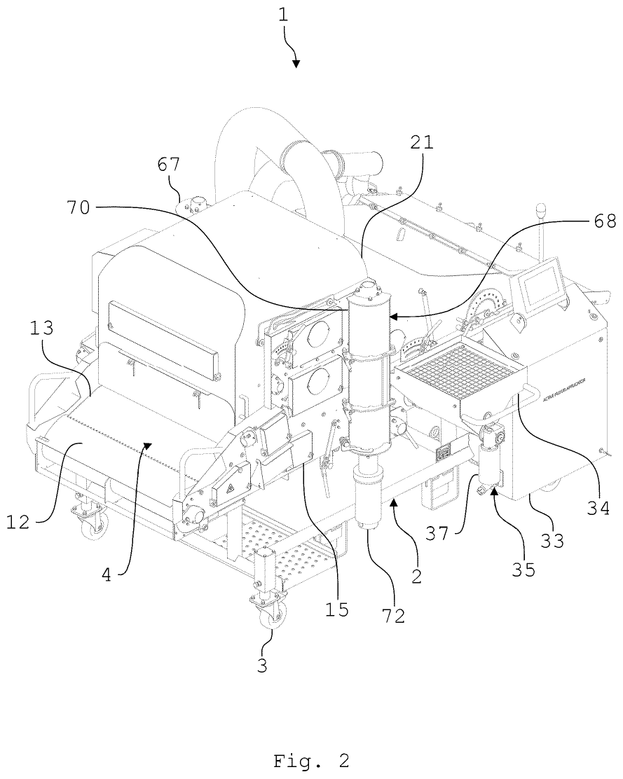

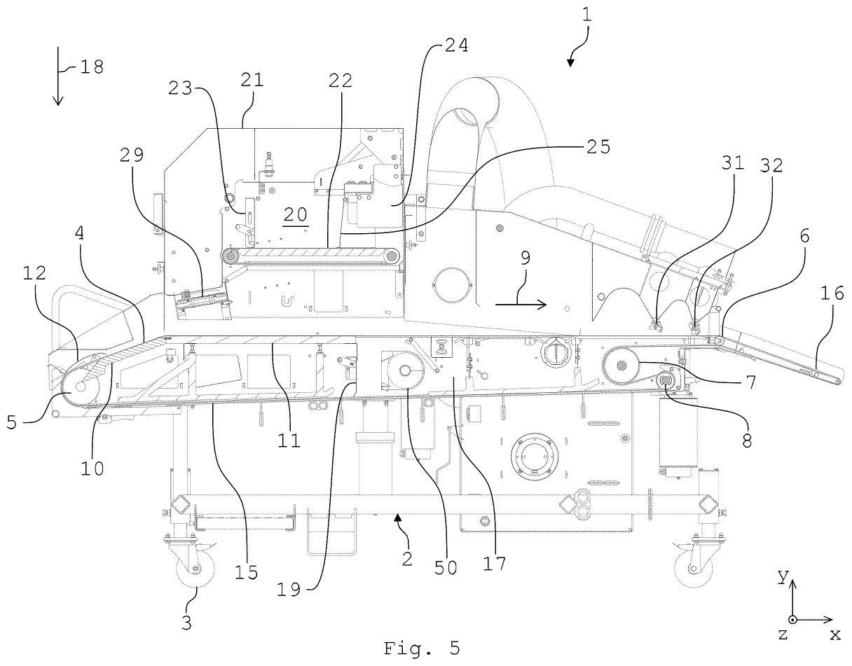

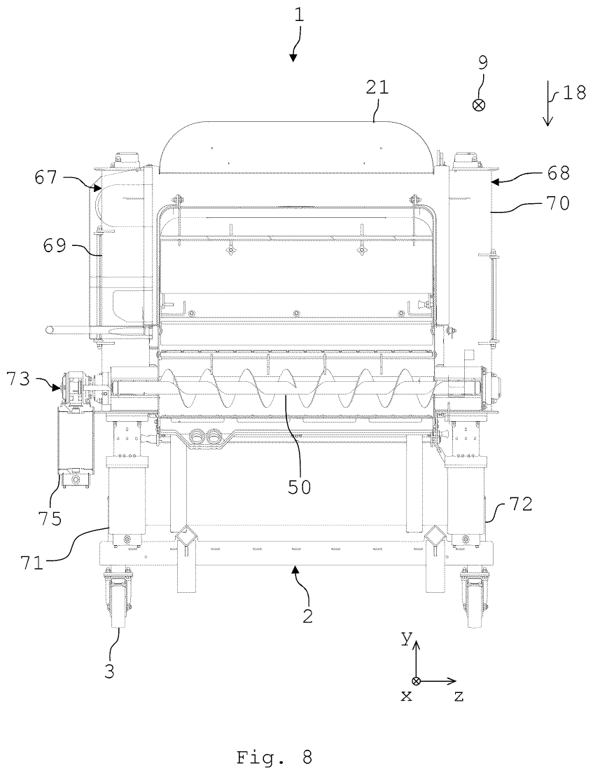

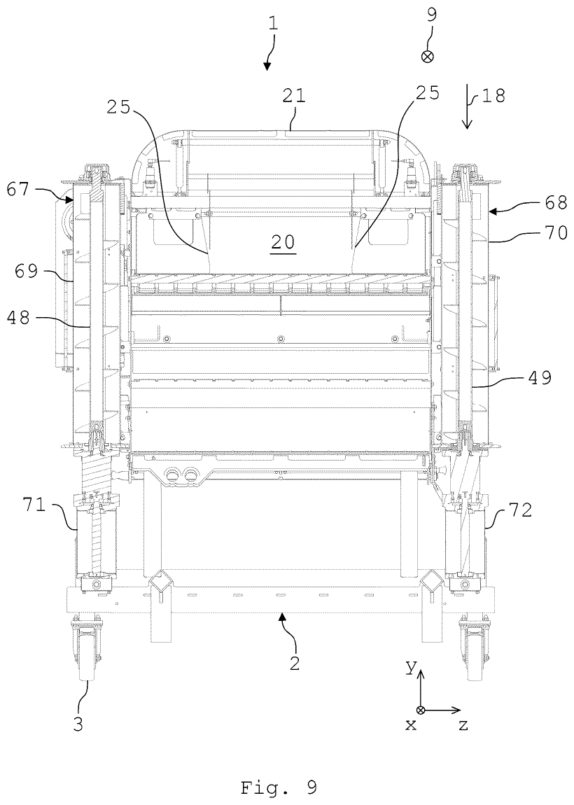

FIG. 1 shows a schematic perspective view of one embodiment of a coating device 1 for coating a food product with a pulverulent material. FIGS. 2 to 4 each show further perspective views of the coating device 1. FIGS. 5 to 9 show different cross-sectional views of the coating device 1. In the following, FIGS. 1 to 9 will be referred to at the same time.

The coating device 1 is described with reference to a coordinate system comprising a length direction or x-direction x, a height direction or y-direction y and a width direction or z-direction z. The directions x, y, z are arranged perpendicular to each other.

The food product (not shown) can be fish or meat like poultry, beef, lamb, or the like. In particular, the food product is a thin cut of fish or meat. The pulverulent material (not shown) can be flour or fine breadcrumbs. The function of the coating device 1 is to coat the food product completely with the pulverulent material. After coating the food product, it can be fried, frozen or processed further in any arbitrary way. The coating device 1 can be named flour applicator or active flour applicator.

The coating device 1 comprises a frame 2 that has a plurality of wheels 3 of which only one is provided with a reference sign. For example, there are provided four wheels 3. By means of the wheels 3, the coating device 1 is transportable and can be easily placed at a desired installation space of the coating device 1.

For conveying the food product, the coating device has a conveyor belt 4 that is guided around rollers 5 to 8. The rollers 5 to 8 are rotatably supported at the frame 2. At least one of the rollers 5 to 8 is driven by a drive element, for example an electric motor. The conveyor belt 4 is an endless belt. The conveyor belt 4 is made of a wire material, in particular a wire mesh. Thus, the conveyor belt 4 is permeable for the pulverulent material. The conveyor belt 4 transports the food product through the coating device 1 along a conveying direction 9. The conveying direction 9 is arranged parallel to the x-direction x. In the orientation of FIG. 5, the conveyor belt 4 runs clockwise.

The conveyor belt 4 has guide plates 10 to 12 for guiding the conveyor belt 4. The conveyor belt 4 has a first lateral side 13 and a second lateral side 14. The conveyor belt 4 is at least partly arranged in a housing 15 of the coating device 1. The frame 2 carries the housing 15. Downstream the conveyor belt 4, an outlet belt 16 is provided.

A lower bunker 17 for storing the pulverulent material and for receiving the pulverulent material that passes through the conveyor belt 4 along a direction of gravity 18. A plate 19 is provided for retaining the pulverulent material in the lower bunker 17 and to create a buffer of the pulverulent material in the lower bunker 17.

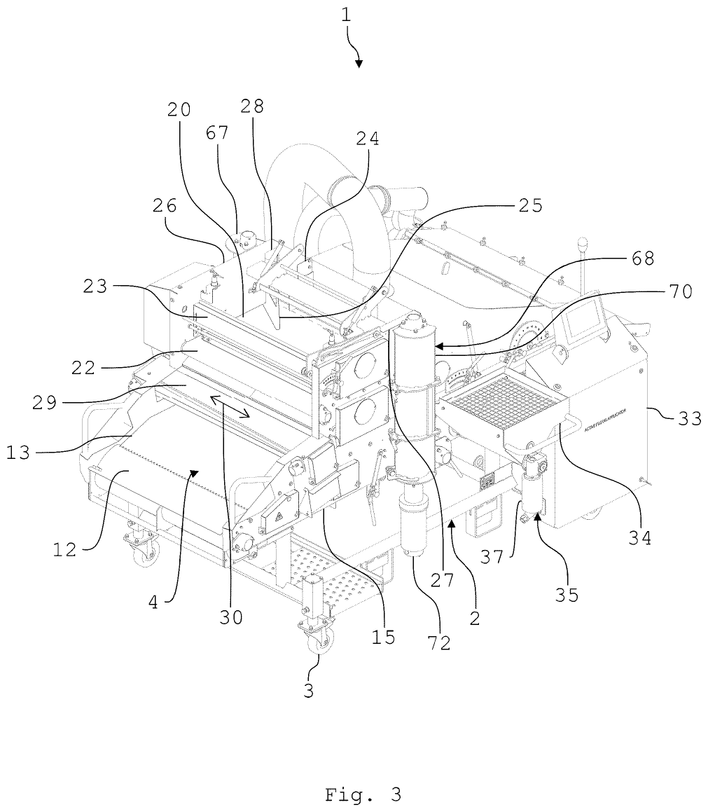

Apart from the lower bunker 17, the coating device 1 comprises an upper bunker 20 for storing the pulverulent material. The upper bunker 20 is covered by a hood 21 that is removed in FIG. 3. The upper bunker 20 has a conveyor belt 22 for conveying the pulverulent material against an adjustable plate 23. The upper bunker 20 has guide plates 24, 25 for guiding the pulverulent material. There are provided two pairs of guide plates 24, 25.

The upper bunker 20 has two opposing sidewalls 26, 27. Each sidewall 26, 27 has an inlet opening 28 through which the pulverulent material enters the upper bunker 20. Only one inlet opening 28 is shown in FIG. 3. Downstream the conveyor belt 22, a coater 29 is provided. The coater 29 applies the pulverulent material to the food product being conveyed by the conveyor belt 4. The coater 29 is a shaking belt or comprises a shaking belt that moves to the left and to the right in a direction 30 that is arranged perpendicular to the conveying direction 9. The direction 30 is arranged parallel to the z-direction.

The coating device 1 can comprises a plurality of air knives 31, 32 of which two can be arranged over the conveyor belt 4 and one (not shown) is provided below the conveyor belt 4. The air knives 31, 32 remove superfluous pulverulent material from the food product before the food product is supplied to the outlet belt 16 by blowing compressed air from the air knives towards the food product. The coating device 1 further has a controller 33 for controlling the coating device 1.

An external bunker 34 is provided to supply the pulverulent material to the lower bunker 17. The external bunker 34 can be funnel-shaped. The external bunker 34 can be part of the coating device 1. A supply screw conveyor 35 for supplying the pulverulent material from the external bunker 34 to the lower bunker 17 is provided.

The supply screw conveyor 35 comprises a supply conveying screw 36 that is driven by a drive 37 to rotate the supply conveying screw 36 around an axis of rotation 38. The axis of rotation 38 is arranged vertically. “Vertically” in this context means that the axis of rotation 38 is arranged parallel to the z-direction z. The drive 37 is an electric motor.

The supply conveying screw 36 has a shaft 39 that is coupled to the drive 37 and a thread 40 that is connected to the shaft 39. The thread 40 has a changing slope. This means that the slope of the thread 40 is not constant but gets less steep when seen along the shaft 39 from the external bunker 34 to the lower bunker 17. This shape of the thread 40 helps to empty the external bunker 34 evenly.

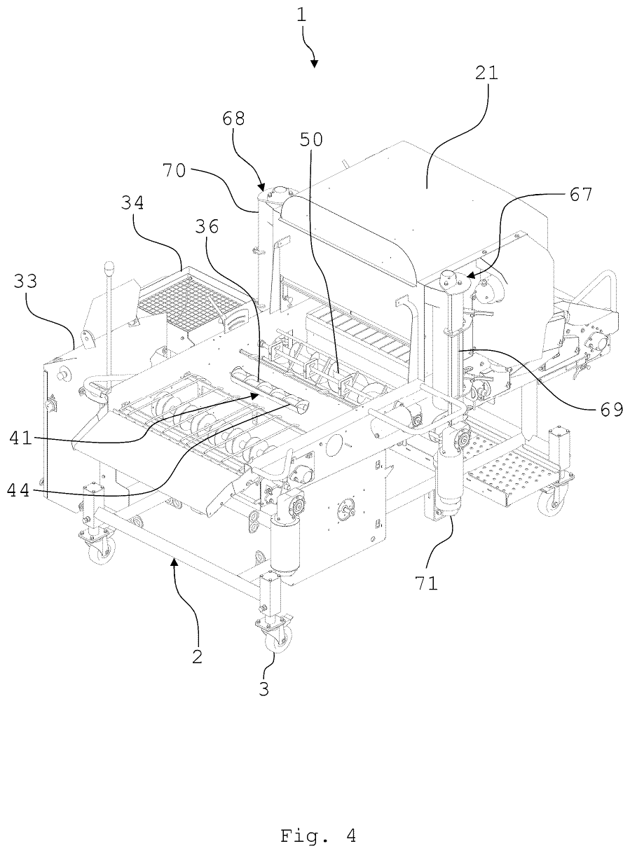

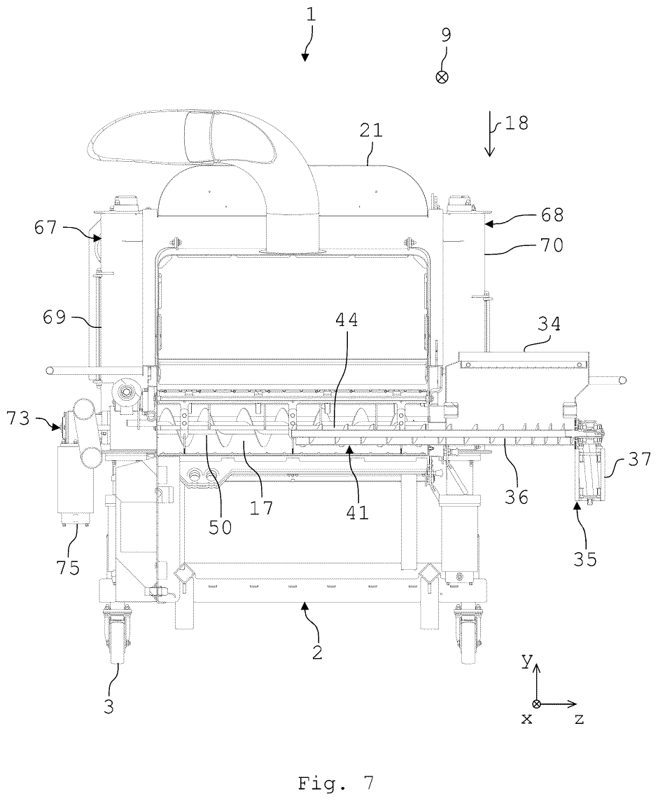

The supply screw conveyor 35 further comprises a supply housing 41 that receives the supply conveying screw 36. The supply housing 41 is tube-shaped and protrudes into the lower bunker 17. The supply housing 41 has an open end 42 that faces the lower bunker 17. An end 43 of the supply conveying screw 36 protrudes out of the end 42 into the lower bunker 17. The supply housing 41 has a circumferential opening 44 (FIGS. 4 and 7). “Circumferential” in this context means that the supply housing 41 is not completely closed when seen around its circumference.

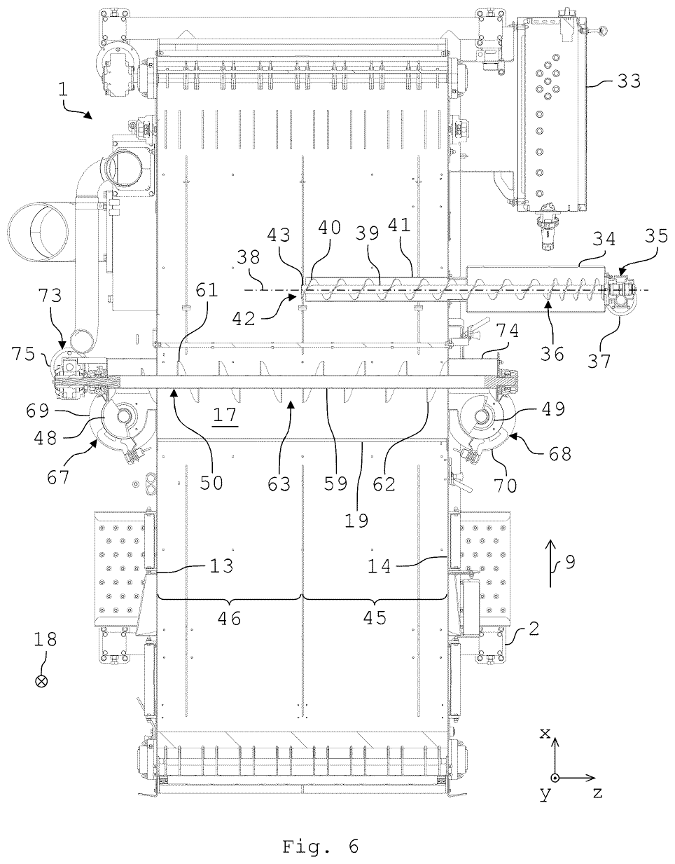

The supply screw conveyor 35 protrudes into the lower bunker 17. However, when seen along the z-direction z, the supply screw conveyor 35 ends essentially in the middle between the lateral sides 13, 14 of the conveyor belt 4. As can be seen from FIG. 6, the conveyor belt 4 can be split along the z-direction z into a first portion or first half 45 and a second portion or second half 46.

The supply screw conveyor 35 directly discharges the pulverulent material from the external bunker 34 into the second half 46. Since the supply housing 41 has the circumferential opening 44, the pulverulent material leaks out of the circumferential opening 44 into the first half 45. Thus, a leaking supply of the pulverulent material to the first half 45 is provided.

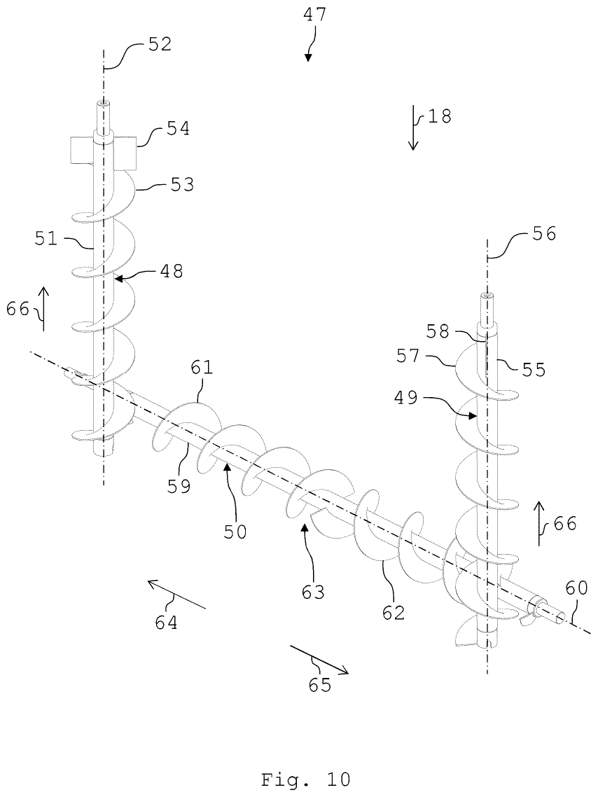

The coating device 1 further comprises a conveying apparatus 47 (FIG. 10) for conveying the pulverulent material from the lower bunker 17 to the upper bunker 20. The conveying apparatus 47 comprises a first upwards conveying screw 48 for transporting the pulverulent material from the lower bunker 17 to the upper bunker 20, a second upwards conveying screw 49 for transporting the pulverulent material from the lower bunker 17 to the upper bunker 20, and a lateral conveying screw 50 for transporting the pulverulent material from the lower bunker 17 to the upwards conveying screws 48, 49.

The first upwards conveying screw 48 and the second upwards conveying screw 49 can be arranged vertically. That means that the upwards conveying screws 48, 49 can be arranged parallel to the y-direction y. Thus, the first upwards conveying screw 48 can be named first vertical screw, and the second upwards conveying screw 49 can be named second vertical screw. The lateral conveying screw 50 can be arranged horizontal. Thus, the lateral conveying screw 50 can be named horizontal screw.

The first upwards conveying screw 48 comprises a shaft 51 that can be rotated around an axis of rotation 52 and a thread 53 being connected to the shaft 51. The axis of rotation 52 can be arranged parallel to the y-direction y. However, the axis of rotation 52 can also be inclined toward the y-direction y. The thread 53 is constant when seen along the shaft 51. The first upwards conveying screw 48 has at least one end plate 54 that is connected to the shaft 51.

The second upwards conveying screw 49 comprises a shaft 55 that can be rotated around an axis of rotation 56 and a thread 57 being connected to the shaft 55. The axis of rotation 56 can be arranged parallel to the y-direction y. However, the axis of rotation 56 can also be inclined toward the y-direction y. The thread 57 is constant when seen along the shaft 55. The second upwards conveying screw 49 has at least one end plate 58 that is connected to the shaft 55.

The lateral conveying screw 50 has a shaft 59 that rotates around an axis of rotation 60. The axis of rotation 60 is arranged parallel to the z-direction z. “Horizontal” or “lateral” in this context can mean parallel to the z-direction z. The lateral conveying screw 50 has a first thread 61 and a second thread 62. A gap 63 is provided between the threads 61, 62. The threads 61, 62 are wound opposite. The first thread 61 is wound counterclockwise, whereas the second thread 62 is wound clockwise. The gap 63 is centered between the lateral sides 13, 14 of the conveyor belt 4.

The conveying apparatus 47 is configured to convey the pulverulent material from the lower bunker 17 against the direction of gravity 18 into the upper bunker 20. The first thread 61 conveys the pulverulent material in a first conveying direction 64 that is oriented from the gap 63 toward the first upwards conveying screw 48. The second thread 62 conveys the pulverulent material in a second conveying direction 65 that is oriented from the gap 63 toward the second upwards conveying screw 49.

The conveying directions 64, 65 are oriented opposite. The first conveying direction 64 can be oriented against the z-direction z. The second conveying direction 65 can be oriented along the z-direction z. Both upwards conveying screws 48, 49 transport the pulverulent material in a third conveying direction 66. The third conveying direction 66 can be oriented along the y-direction and against the direction of gravity 18.

Now returning to FIGS. 1 to 9, the first upwards conveying screw 48 is part of a first upwards screw conveyor 67 and the second upwards conveying screw 49 is part of a second upwards screw conveyor 68. The first upwards screw conveyor 67 can be named first vertical screw conveyor. The second upwards screw conveyor 68 can be named second vertical screw conveyor.

Each upwards screw conveyor 67, 68 has a housing 69, 70 that receives one of the upwards conveying screws 48, 49. Furthermore, each upwards screw conveyor 67, 68 has a drive 71, 72 for driving one of the upwards conveying screws 48, 49. The drives 71, 72 can be electric motors. The housings 69, 70 discharge into the upper bunker 20 throughout the inlet openings 28 of the sidewalls 26, 27.

The lateral conveying screw 50 is part of a lateral screw conveyor 73 with a housing 74. The lateral conveying screw 50 is driven by a drive 75. The drive 75 is an electric motor. The lateral screw conveyor 73 can be named horizontal screw conveyor.

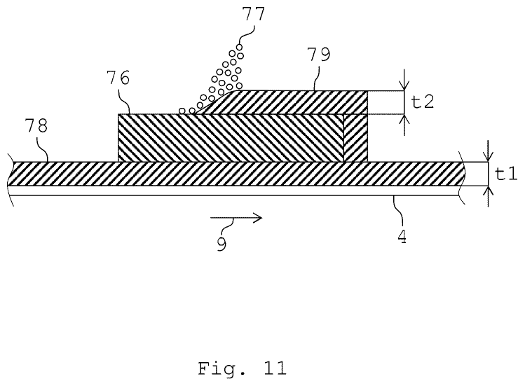

The functionality of the coating device 1 will be explained in the following with reference to FIGS. 1 to 10 and FIG. 11 that shows a cross-sectional view of a food product 76. In the lower bunker 17 a buffer of the pulverulent material 77 is provided. By adjusting a gap between the plate 19 and the housing 15, a thickness t1 of a first layer 78 of the pulverulent material 77 can be adjusted.

The conveyor belt 4 transports the pulverulent material 77 around the roller 5 by means of the guide plate 12. The first layer 78 is then guided on the guide plate 10, wherein the food product 76 is placed on the first layer 78 in the area of the guide plate 10. This can be done by means of a supply belt (not shown).

As soon as the food product 76 reaches the coater 29, the pulverulent material 77 from the upper bunker 20 is supplied to the food product 76 by means of the coater 29. The coater 29 produces an evenly second layer 79 of the pulverulent material 77 on top of the food product 76 so that the food product 76 is completely covered with the pulverulent material 77.

The conveyor belt 22 conveys the pulverulent material 77 from the upper bunker 20 to the coater 29. A thickness t2 of the second layer 79 can be adjusted by means of the plate 23. After passing the coater 29, the covered food product 76 enters the housing 15. As soon as the food product 76 passed the guide plate 11, the pulverulent material 77 that is not adhered to the food product 76 passes the mesh-shaped conveyor belt 4 and falls into the lower bunker 17.

The air knives 31, 32 further remove rests of the pulverulent material 77 that is not completely adhered to the food product 76. This pulverulent material 77 is conveyed to the lower bunker 17 by means of the conveyor belt 4.

The lateral screw conveyor 73 transports the pulverulent material 77 from the lower bunker 17 to the upwards screw conveyors 67, 68 that are arranged on both lateral sides 13, 14 of the conveyor belt 4. The upwards screw conveyors 67, 68 then transport the pulverulent material 77 upwards in the third conveying direction 66 to the upper bunker 20.

The pulverulent material 77 enters the upper bunker 20 through the inlet openings 28 of the sidewalls 26, 27 of the upper bunker 20. The pulverulent material 77 is transported through the inlet openings 28 by means of the end plates 54, 58. The pulverulent material 77 is guided against the guide plates 24 and is evenly distributed by means of the guide plates 25.

The supply screw conveyor 35 supplies the pulverulent material 77 from the external bunker 34 to the lower bunker 17, so that the buffer of pulverulent material 77 in the lower bunker 17 can be kept constant.

Since there are provided two upwards screw conveyors 67, 68 instead of only one, an equally distribution of the pulverulent material 77 in the upper bunker 20 is ensured. For example, this evenly distribution of the pulverulent material 77 enables to increase a width of the conveyor belt 4 while still receiving a good covering result of the food product 76.

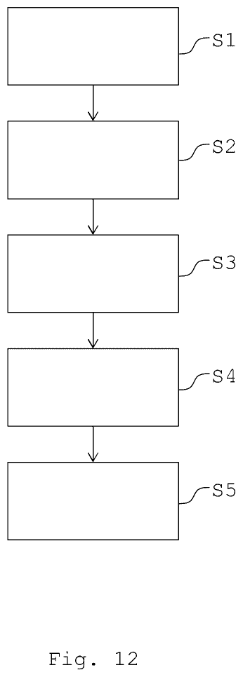

FIG. 12 shows a flowchart of one embodiment of a method for coating the food product 76 with the pulverulent material 77 by means of the coating device 1.

In a step S1, the food product 76 is conveyed to the coater 29 by means of the conveyor belt 4. Hence, the food product 76 lies on the first layer 78 of the pulverulent material 77. The food product 76 is coated with the pulverulent material 77 in a step S2 by means of the first layer 78 of the pulverulent material 77 that lies on the conveyor belt 4 and the second layer 79 of the pulverulent material 77 that is applied to the food product 76 by means of the coater 29.

In a step S3, the pulverulent material 77 that passes through the conveyor belt 4 is received in the lower bunker 17. The lower bunker 17 also stores the pulverulent material 77. The pulverulent material 77 is then conveyed in a step S4 from the lower bunker 17 to the upper bunker 20 on both lateral sides 13, 14 of the conveyor belt 4 by means of the first upwards screw conveyor 67 and the second upwards screw conveyor 68. Thus, the upper bunker 20 is symmetrically filled.

In a step S5, the pulverulent material 77 is supplied from the external bunker 34 to the lower bunker 17 by means of the supply screw conveyor 35. Preferably, the supply screw conveyor 35 replaces the pulverulent material 77 that is removed from the coating device 1 by coating the food product 76. Thus, the pulverulent material 77 that leaves the coating device together with the food product 76 is replaced. The steps S1 to S5 can be performed subsequently or at the same time.

Although the present invention has been described in accordance with preferred embodiments, it is obvious for the person skilled in the art that modifications are possible in all embodiments.

1.-15. (canceled)

16. A coating device for coating a food product with a pulverulent material, comprising:
a conveyor belt arranged in a housing for conveying the food product in a conveying direction,
wherein the conveyor belt is at least partly permeable for the pulverulent material,
wherein a guide plate provided at an upstream end under the conveyor belt, seen in conveying direction, prevents the pulverulent material from passing the conveyor belt, generating a first layer of the pulverulent material that lies on the conveyor belt onto which the food product is placeable,
an upper bunker for storing the pulverulent material,
a coater for applying a second layer of the pulverulent material to the food product being conveyed by the conveyor belt,
wherein the coater is supplied with the pulverulent material from the upper bunker,
a lower bunker arranged within the conveyor belt for storing the pulverulent material and for receiving the pulverulent material that passes through the conveyor belt downstream of the guide plate, seen in conveying direction,
a plate delimiting an upstream end of the lower bunker for retaining the pulverulent material in the lower bunker and to create a buffer of the pulverulent material in the lower bunker,
wherein by adjusting a gap between the plate and the housing a thickness of a first layer of the pulverulent material can be adjusted,
a first upwards screw conveyor for conveying the pulverulent material from the lower bunker to the upper bunker,
a second upwards screw conveyor for conveying the pulverulent material from the lower bunker to the upper bunker,
wherein the first upwards screw conveyor and the second upwards screw conveyor are arranged on both lateral sides of the conveyor belt,
a lateral screw conveyor provided in the lower bunker for conveying the pulverulent material to the first upwards screw conveyor and to the second upwards screw conveyor, and
a supply screw conveyor protruding into the lower bunker downstream of the lateral screw conveyor for conveying the pulverulent material from an external bunker to the lower bunker.

17. The coating device according to claim 16, wherein the lateral screw conveyor comprises a lateral conveying screw,
wherein the lateral conveying screw has a first thread and a second thread, and
wherein the first thread and the second thread have opposite directions of rotation.

18. The coating device according to claim 17, wherein the first thread and the second thread meet at a center between the lateral sides of the conveyor belt.

19. The coating device according to claim 18, wherein the first thread is configured to convey the pulverulent material from the center between the lateral sides toward a first lateral side of the conveyor belt, and
wherein the second thread is configured to convey the pulverulent material from the center between the lateral sides toward a second lateral side of the conveyor belt.

20. The coating device according to claim 17, wherein the first thread and the second thread share a common shaft of the lateral conveying screw.

21. The coating device according to claim 20, wherein the first thread and the second thread have the same length when seen along the shaft.

22. The coating device according to claim 16, wherein a conveying direction of the upwards screw conveyors is arranged perpendicular toward a first conveying direction of the lateral screw conveyor and toward a second conveying direction of the lateral screw conveyor, and
wherein the first conveying direction and the second conveying direction are oppositely oriented.

23. The coating device according to claim 16, wherein the upper bunker comprises a first inlet opening for the first upwards screw conveyor and a second inlet opening for the second upwards screw conveyor, and
wherein the first inlet opening and the second inlet opening are provided at opposing sidewalls of the upper bunker.

24. The coating device according to claim 16, wherein an axis of rotation of the first upwards screw conveyor and an axis of rotation of the second upwards screw conveyor are arranged parallel to each other, and
wherein an axis of rotation of the lateral screw conveyor is arranged perpendicular to the axes of rotation of the upwards screw conveyors.

25. The coating device according to claim 24, wherein an axis of rotation of the supply screw conveyor is arranged parallel to the axis of rotation of the lateral screw conveyor.

26. The coating device according to claim 16, wherein the supply screw conveyor laterally protrudes into the lower bunker, and
wherein an end of the supply screw conveyor is arranged centered in relation to the conveyor belt or ends just over a first half of the conveyor belt.

27. The coating device according to claim 26, wherein the supply screw conveyor comprises a supply conveying screw and a supply housing for receiving the supply conveying screw, and
wherein the supply housing comprises a circumferential opening for a leaking distribution of the pulverulent material into the lower bunker.

28. The coating device according to claim 27, wherein the circumferential opening is configured to provide a leaking distribution of the pulverulent material onto the first half of the conveyor belt.

29. A method for coating a food product with a pulverulent material by a coating device for coating the food product according to claim 16,
wherein the coating device comprises a conveyor belt, an upper bunker, a coater, a first upwards screw conveyor, a second upwards screw conveyor, a lateral screw conveyor, and a supply screw conveyor, the method comprising the following steps:
a) conveying the food product to the coater by the conveyor belt,
b) coating the food product with the pulverulent material by a first layer of the pulverulent material that lies on the conveyor belt and a second layer of the pulverulent material that is applied to the food product by the coater,
c) receiving pulverulent material that passes through the conveyor belt in the lower bunker,
d) conveying pulverulent material from the lower bunker to the upper bunker on both lateral sides of the conveyor belt by the first upwards screw conveyor and the second upwards screw conveyor, and
e) conveying pulverulent material from an external bunker to the lower bunker by the supply screw conveyor.

30. The method according to claim 29, wherein during step e), the supply screw conveyor replaces pulverulent material that is removed from the coating device by coating the food product.
